(19) United States
(12) Patent Application Publication
(10) Pub. No.: US 2021/0094710 A1
(43) Pub. Date: Apr. 1, 2021

(54) TEST CELLS AND DECISION MATRIX FOR SPACE-DESTINED PAYLOADS

(71) Applicant: Space Simulation Services of Ottawa Corporation, Ottawa (CA)

(72) Inventor: Michael Raymond Richard Graham, Kemptville (CA)

(21) Appl. No.: 17/037,872

(22) Filed: Sep. 30, 2020

Related U.S. Application Data
(60) Provisional application No. 62/908,493, filed on Sep. 30, 2019.

(51) Int. Cl. B64G 7/00; B64G 1/64; G06F 11/36

(52) U.S. Cl. CPC B64G 7/00; B64G 1/641; B64G 2007/005; G06F 11/3688; G06F 11/3684

(57) ABSTRACT

A computer-implemented system and method for testing a space-destined payload in which the system comprises one or more test cells. Each test cell designed to test a space-destined payload within a test environment. Payload specifics and the payload space trajectory are provided to the system, which then designs a test environment for each test cell and then executes one or more tests on the payload within the test environment of each cell.

### REFERENCE TO RELATED APPLICATION

This application claims the benefit of U.S. Provisional Patent Application No. 62/908,493, filed Sep. 30, 2019, which is hereby incorporated by reference in its entirety.

### FIELD OF THE INVENTION

The present disclosure relates to the field of simulated space environments; in particular, to remote management, observation of system and test telemetry.

### BACKGROUND

Traditionally, large satellites have been tested prior to launch in large test environments that require months to plan, test and compile data. However, such traditional test facilities are not conducive to rapid processing, nor for testing smaller space-destined payloads (such as components of large satellites or small satellites) and tend to be expensive. Due to the cumbersome design of these traditional, large testing facilities, testing of conventionally large payloads must be done sequentially, rather than in batch, as it is difficult to replicate the facilities as well as to control the cost of such testing.

Currently, there are no efficient ways to manage the testing, tracking and data acquisition of payloads that need to be tested for space applications. The present disclosure addresses these issues by providing integration of tasks and data required to manage required testing procedures.

### BRIEF SUMMARY

In one aspect, there is provided a computer-implemented system for testing a space-destined payload, the system comprising: one or more test cells, each test cell having a simulated space environment designed to test a space-destined payload within the simulated space environment; a processor; and a computer memory storing instructions that, when executed by the processor, configure the system to: receive input information related to payload specifics and a space trajectory of the payload; design the test environment for each test cell based on the input information; and execute one or more tests on the payload within the test environment of each cell.

The one or more test cells can be selected from a thermal-vacuum test cell and a structural test cell and an RF test cell. The thermal-vacuum test cell can comprise a thermal-vacuum chamber for containing the space-destined payload. The system can also provide real-time telemetry data of the payload while being tested in each of the one or more test cells. In some embodiments, the number of cells is greater than one; and the system can operate each test cell simultaneously, in parallel and/or in sequence.

In another aspect, there is provided a non-transitory computer-readable storage medium for testing a space-destined payload, the computer-readable storage medium including instructions that when executed by a computer, cause the computer to: receive input information related to payload specifics and a space trajectory of the payload; design a test environment for one or more test cells based on the input information; and execute one or more tests on the payload within the test environment of each cell. In some embodiments, the one or more test cells may be selected from a thermal-vacuum test cell and a structural test cell and an radio-frequency (RF) test cell. The thermal-vacuum test cell may comprise a thermal-vacuum chamber for containing the space-destined payload.

In some embodiments of the computer-readable storage medium, the instructions, when executed by the computer, further cause the computer to provide real-time telemetry data of the payload while being tested in each of the one or more test cells.

In yet another aspect, there is provided a method for testing a space-destined payload, the method comprising: receiving information related to one or more payload specifics and a space trajectory of the payload; designing a test environment for the payload, based on the information; loading the payload into a first test cell of one or more test cells; and executing a first set of tests related to the test environment in the first test cell. In some embodiments, the first test cell can be one of a thermal-vacuum test cell, a structural test cell, or an RF test cell. The thermal-vacuum test cell may comprise a thermal-vacuum chamber.

In some embodiments the method further comprises, after executing the first set of tests, loading the payload into a second test cell of the one or more test cells; and executing a second set of tests related to the test environment in the second test cell.

In some embodiments the method further comprises, after executing the second set of tests, loading the payload into a third test cell of the one or more test cells; and executing a third series of tests related to the test environment in the third test cell.

In some embodiments the method further comprises providing real-time telemetry data of the payload in the test environment.

Disclosed herein are three types of test cells (or facilities): thermal, structural and RF. Each type is required to meet certain specifications. As part of the testing process, the conditions that the test object needs to meet is provided, through, for example, a selection matrix (or flowchart) accessed by a client. The selection matrix selects the parameters of testing based on the specifics of the payload. For example, a user will specify how high the payload will orbit around the earth. The decision matrix is a workflow engine that designs the testing process.

The testing takes place in the one or more cells, with the decision matrix integrated into each cell design. The cell outputs data live, which can be accessed instantaneously (as opposed to the traditional, large-scale facility).

In addition, each cell can be replicated for testing payloads in batch, rather than sequentially.

Disclosed herein is an integrated testing cell that provides implementation, tracking and observation of testing via a local and remote GUI (Graphical User Interface). Disclosed herein are one or more computer-implemented methods that track, log and display all inputs used by the system and users.

Disclosed herein is an end-to-end process for implementing, capturing and accommodating regular simulated space requirements for payloads.

Disclosed herein are one or more computer-implement methods that comprise capture of key points throughout the process, telemetry from a thermal-vacuum chamber, a shaker and an RF chamber. The one or more computer-implement methods display the telemetry onto a graphical user interface, stream the requested data online through the website and log all of the telemetry.

The process comprises receipt of a payload, unpacking, inspection, setup, installation, verification of installation, beginning of environment process, client testing of hardware, acknowledging all variance, completing environment process, verification of installation, removal, repeat at next facility then to dismantle, inspect, pack and ship.

Telemetry from the thermal-vacuum chamber can be captured at a rate of 1 data point/minute in voltage, current or resistance readings. Telemetry from the shaker can be captured at a desired rate in a desired form. Telemetry from the RF chamber can be captured at the desired rate and desired form.

Graphical User Interfaces may capture each system separately; a system can be a cleanroom and liquid nitrogen (LN2), thermal=vacuum chamber, shaker, RF, client data, facility process and status and facility/labor schedule.

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a thermal vacuum cell in accordance with one embodiment.

FIG. 2 illustrates a connected thermal vacuum chamber in accordance with one embodiment.

FIG. 3 illustrates a partial view of a thermal vacuum cell in accordance with one embodiment.

FIG. 4 illustrates a view of the embodiment shown in FIG. 3.

FIG. 5 illustrates a thermal vacuum chamber in the embodiment shown in FIG. 3.

FIG. 6 illustrates a thermal-vacuum chamber in accordance with one embodiment.

FIG. 7 illustrates a second view of the thermal-vacuum chamber shown in FIG. 6.

FIG. 8 illustrates a thermal-vacuum chamber in accordance with one embodiment.

FIG. 9 illustrates the thermal-vacuum chamber shown in FIG. 8.

FIG. 10 illustrates a sectional view of the thermal-vacuum chamber shown in FIG. 9.

FIG. 11 illustrates a flowchart in accordance with one embodiment.

FIG. 12 illustrates a computer system for testing a space-destined payload in accordance with one embodiment.

### DETAILED DESCRIPTION

A scenario is a specific set of automated instructions that enable a user to carry out several operations related to facilities, Data Acquisition Units (DAQ) and displays.

As an example, a component to be tested arrives at the facility in a “to be fully tested” scenario which may comprise: agreeing to a test procedure and profiles, a baseline test, log-in of equipment into thermal-vacuum facility to be tested, unpacking, verification, setup onto fixture, instrumenting of component, verify instrumentation, install fixture, document with pictures, seal chamber, agree to begin test profile with signoff, begin test profile, observe and log test data, adjust profile/test parameters according to client request or system requirement, complete profile, authorize test stop and recover, recover chamber, open door, verify component, document with pictures, uninstall fixture, disassemble instrumentation, repack, log-out of equipment tested, and log into structural facility.

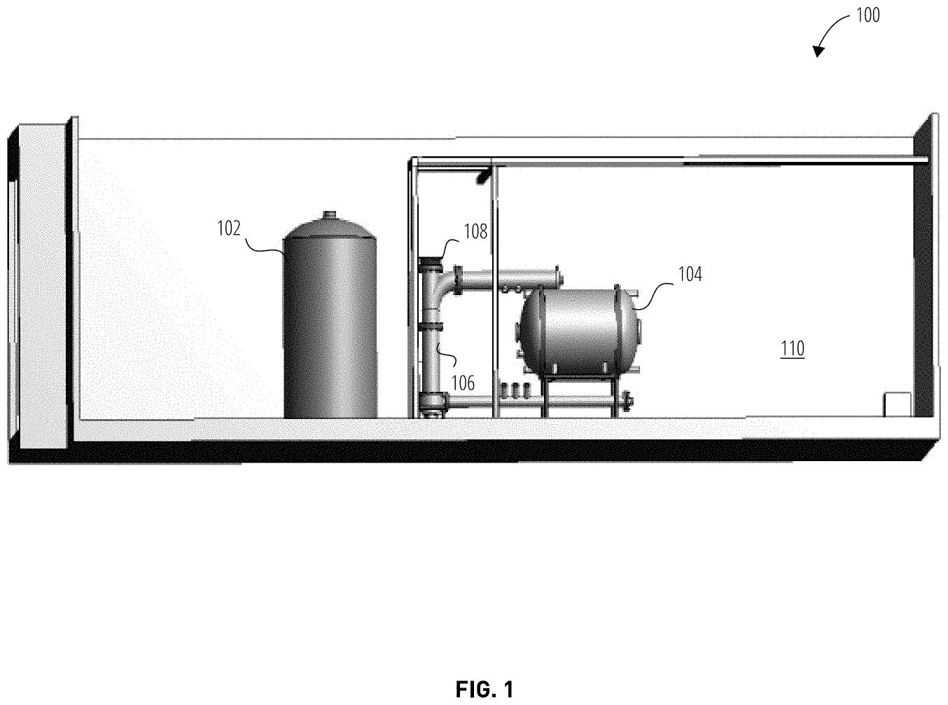

FIG. 1 illustrates a discontinuous thermal vacuum cell 100 in accordance with one embodiment, in which various components are shown without connections. An LN2 tank 102 provides liquid nitrogen to cool the thermal vacuum chamber 104 via a thermal control unit 106. An immersion heater 108 is affixed atop the thermal control unit 106. At the bottom of the thermal control unit 106 lies a blower (or cryogenic unit) to distribute the conditioned nitrogen gas. The blower can have a special seal in order to function at very cold temperatures, as well as a customized belt. In addition, the walls of the blower are thick enough to accommodate temperatures below −150° C. (i.e. the temperature of nitrogen gas).

In some embodiments, the thermal vacuum chamber 104 sits in a clean room 110, while the LN2 tank 102, thermal control unit 106 and immersion heater 108 are placed outside the clean room 110.

In some embodiments, the immersion heater 108 may include primary and redundant thermocouples.

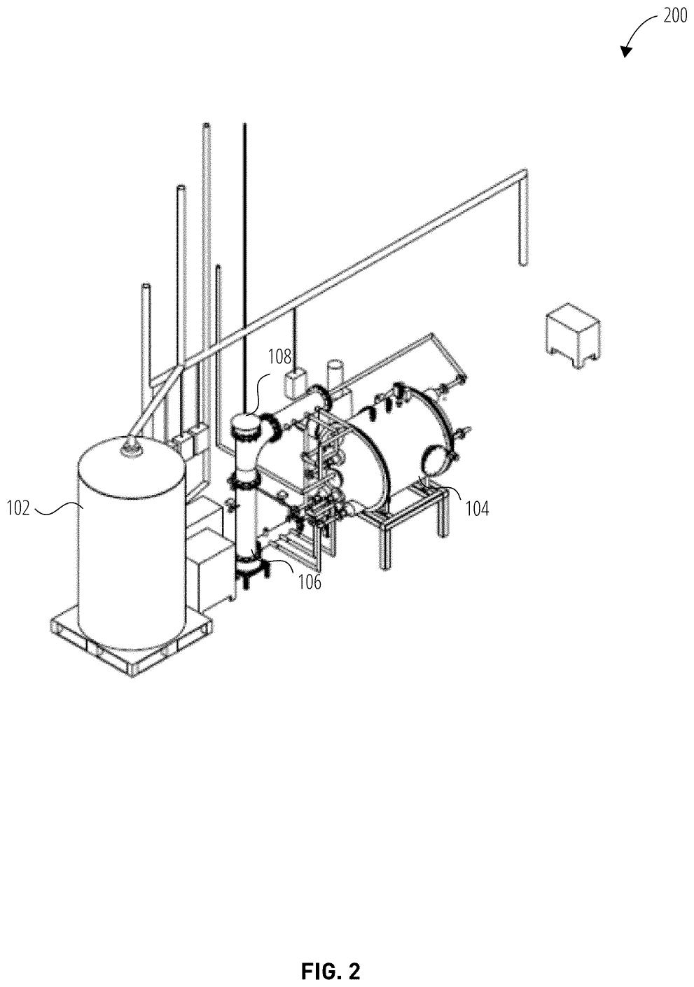

FIG. 2 illustrates a connected thermal vacuum chamber 200 in accordance with one embodiment, in which the LN2 tank 102, thermal control unit 106 and immersion heater 108 are connected to thermal vacuum chamber 104.

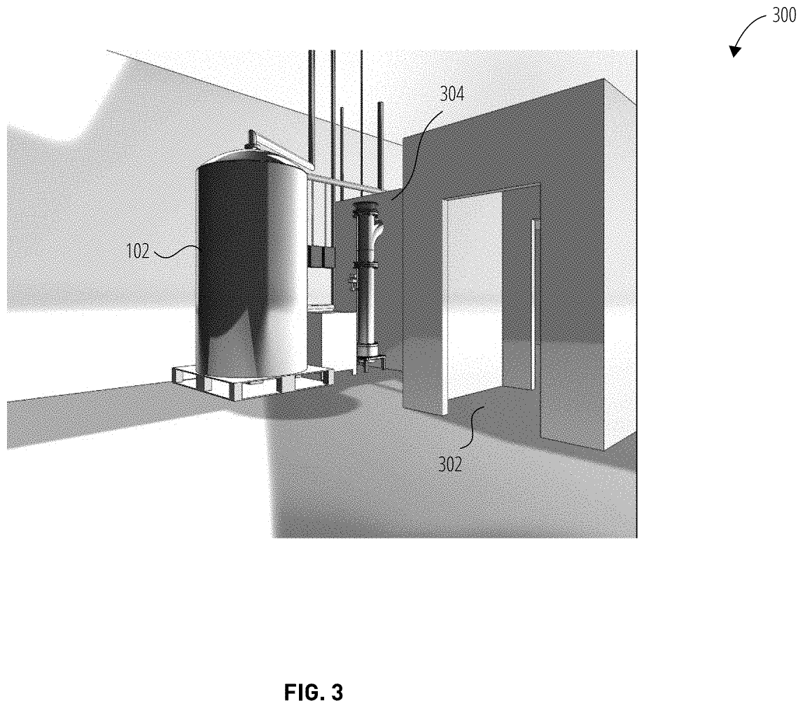

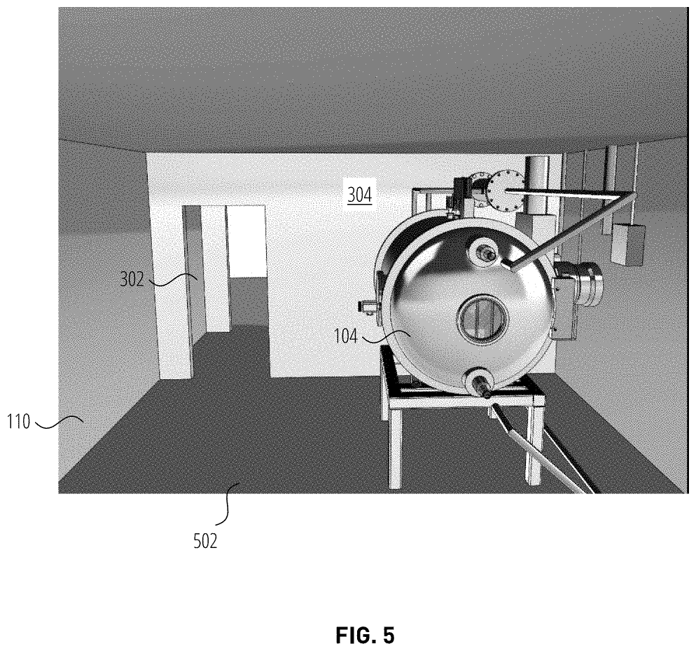

In FIG. 3, an embodiment of an interconnected thermal-vacuum cell 300 is shown in which the LN2 tank 102 is separated from the thermal vacuum chamber by a wall 304. In addition, there is an ante-room 302, which precedes the clean room that contains the thermal vacuum chamber (see FIG. 5). The ante-room 302 is not part of the clean room. The ante-room 302 allows the clean room to go to an ISO5 (i.e. where the particle count is below 100 microns and air velocity is below 10 feet per min). The ante-room 302 maintains the pressure within the clean room, allows individuals to suit up to go into the clean room. The ante-room 302 can have dimensions of 6 ft×6 ft.

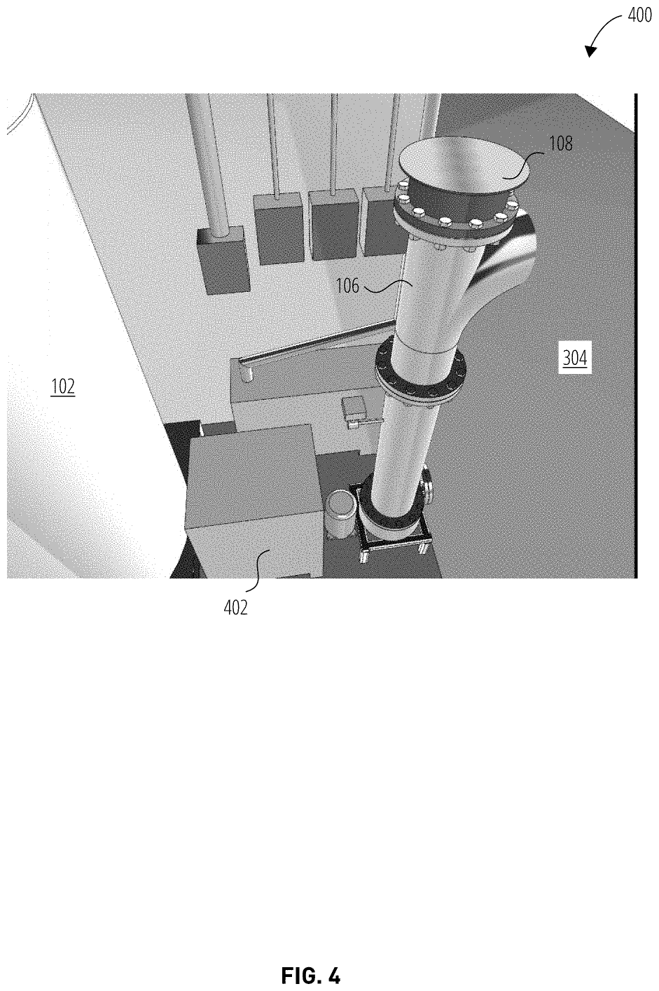

FIG. 4 illustrates an alternative view 400 of the embodiment shown in FIG. 3. The thermal control unit 106 is shown adjacent to the wall 304. The immersion heater 108 is at the top of thermal control unit 106, which acts to regulate the temperature of the nitrogen (the thermal control medium) which then drives the temperature of the zones in the thermal vacuum chamber. On the other side of the wall 304 is the clean room 110. A chiller 402 is illustrated, which is used to regulate the mechanical and high-vacuum pumps bearing temperatures.

FIG. 5 illustrates the thermal vacuum cell shown in FIG. 3, from within the clean room 110, which is blocked off from the LN2 tank by wall 304. Clean room 110 is connected to the ante-room 302 and comprises the thermal vacuum chamber 104.

The dimensions of the clean room 110 may be 16 feet by 23 feet—in contrast to conventional testing centers that are at least 100 ft by 200 ft. The ceiling height of the clean room 110 may be 9 feet—in contrast to a ceiling height of 25 ft for conventional testing centers.

The clean room 110 and the ante-room 302 can have a special electrostatic discharge floor 502 that serves as a ground. Individuals who enter into ante-room 302 and/or clean room 110 may wear special conductive shoes. The floor 502 also can provide a special electrical bond in the electrical room—where the discharge from the electrostatic discharge goes; it is also present for any instruments that may be brought into the clean room 110. The instruments maybe connected to the special electrical bond so that everything is at the same potential.

In some embodiments, a satellite is packed in a special way when it arrives to the test cell. A transitional table can be provided in the ante-room 302 upon which the satellite is placed and rolled into the clean room 110, after which the satellite packaging is removed and kept. The packaging can be a special film.

Similarly, instrumentation can also have special packaging. Like the satellite, instruments also enter the ante-room 302, placed on a transition table, and rolled into the clean room 110, where packaging is removed.

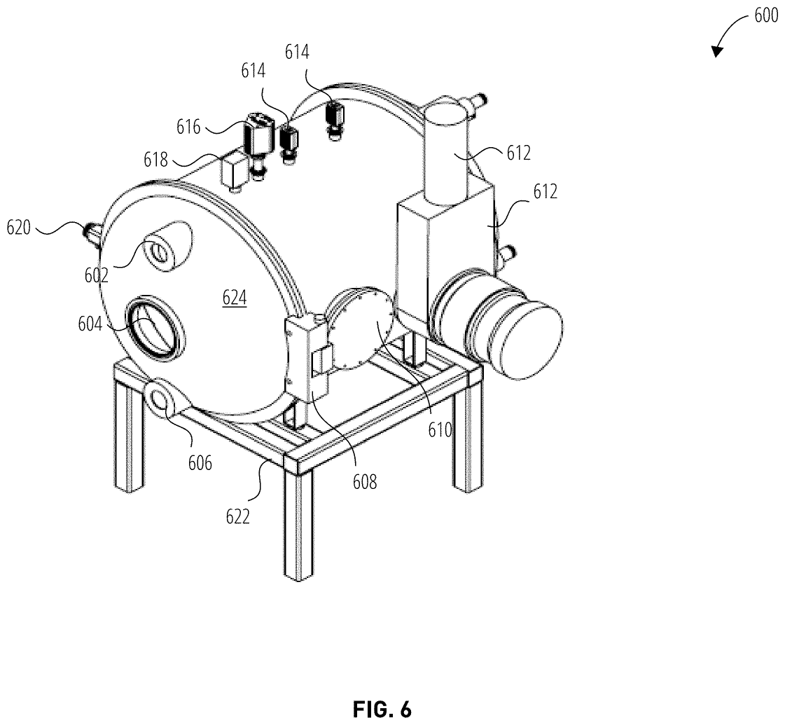

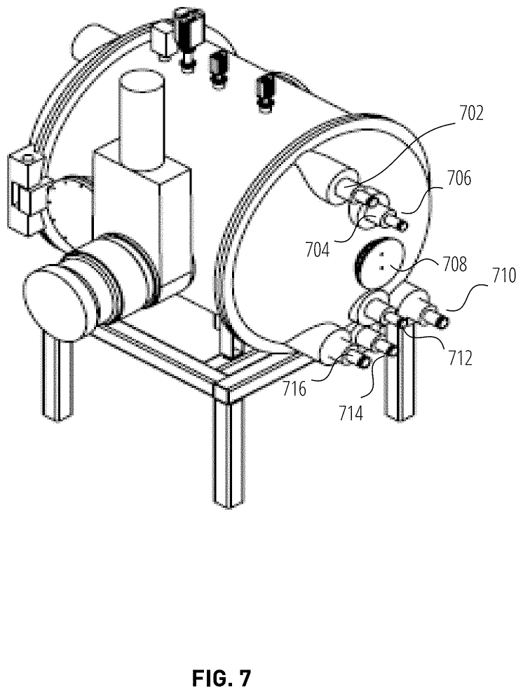

FIG. 6 and FIG. 7 illustrate different views of a thermal-vacuum chamber 600 in accordance with an embodiment. The thermal-vacuum chamber 600 tests a payload (also called “unit under test” or UUT), and can sit on a chamber frame 622 which supports the weight of the thermal-vacuum chamber 600. The chamber frame 622 can be placed at height that is convenient for personnel.

The thermal-vacuum chamber 600 includes a return manifold 602 and a supply manifold 606 in the door 624. An auxiliary port 604 in the door 624 allows for viewing of the UUT inside the thermal-vacuum chamber 600. The design of the auxiliary port 604 is such that internal shrouds (not shown) do not block the view of the UUT.

The supply manifold 606 provides a supply of conditioned nitrogen gas to the door shroud (inside the thermal-vacuum chamber 600). The supply manifold 606 can have a special design that allows for a larger diameter pipe to penetrate through the chamber wall. A hinge mechanism 608 allows for articulation of the door 624, thus allowing for a tight seal.

A client port 610 provides vacuum feedthrough connections to the UUT from the atmosphere and can include a vacuum flange (ISO-type). A high vacuum purge valve 620 serves to isolate nitrogen gas from the vacuum, and allows for multi-use function of the thermal-vacuum chamber 600 by regulating gas flow into the chamber. A quartz crystal microbalance 618 provides quantitative measurement of the chamber environment. For example, the quartz crystal microbalance 618 can measure the outgassing rate of thermal-vacuum chamber 600.

A residual gas analyzer 616 provides quantitative values of the contents of the vacuum. The vacuum transducers 614 measure the vacuum in the chamber. There are two high-vacuum valves 612—in case one fails. Failure can occur, for example, by voltage spikes and/or voltage outages.

In FIG. 7, another view of the thermal vacuum chamber 104 is shown, illustrating a main return 702, a vacuum jacket 704 and a rear shroud return 706. There is also a scavenging plate 708, a platen supply 710, a rear shroud supply 712, a main supply 714 and a platen return 716.

The main return 702 is offset from center of the rear door, thereby allowing for top instruments to have full field of view of the UUT inside the chamber. The main return 702 is offset just enough so that the thermal gradient of the main shroud is acceptable. The scavenging plate 708 condenses all outgassing material so that they do not get deposited on the UUT. The platen supply 710 and the platen return 716 are mounting fixtures that provide a thermal conduction service.

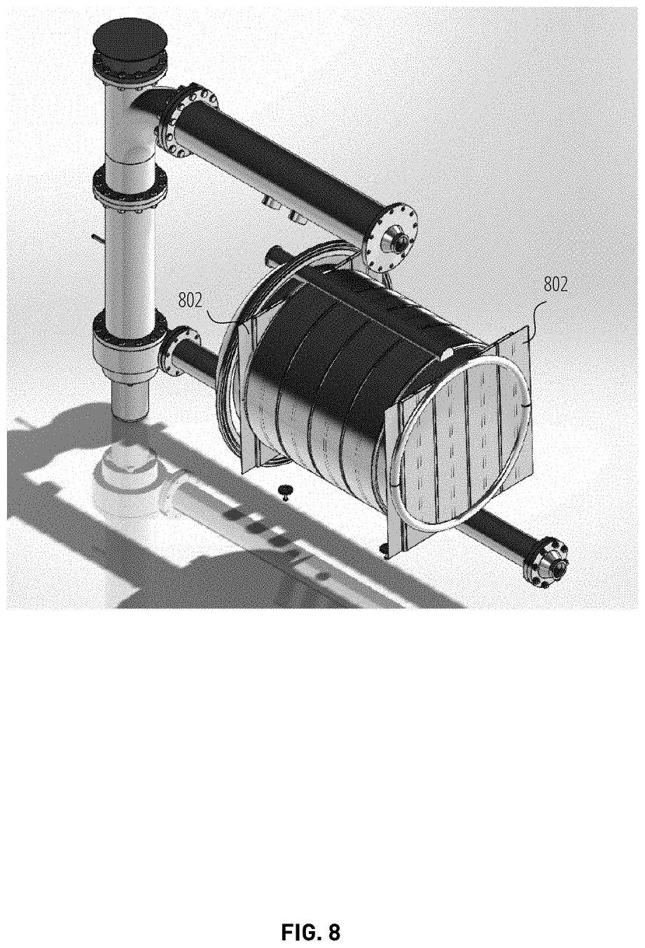

FIG. 8 illustrates a thermal-vacuum chamber in accordance with one embodiment, in which the external shell of the chamber is removed, revealing thermal shrouds 802. Thermal shrouds 802 each provide a thermal load to the UUT. In some embodiments, the shroud is made of aluminum.

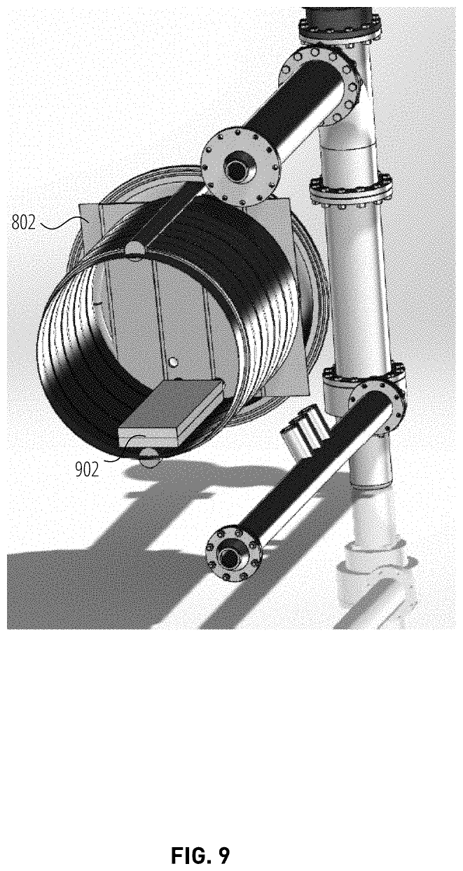

FIG. 9 illustrates the thermal-vacuum chamber shown in FIG. 8, with one of the shrouds removed, showing the platen 902. Ribbing allows the nitrogen gas from supply to return.

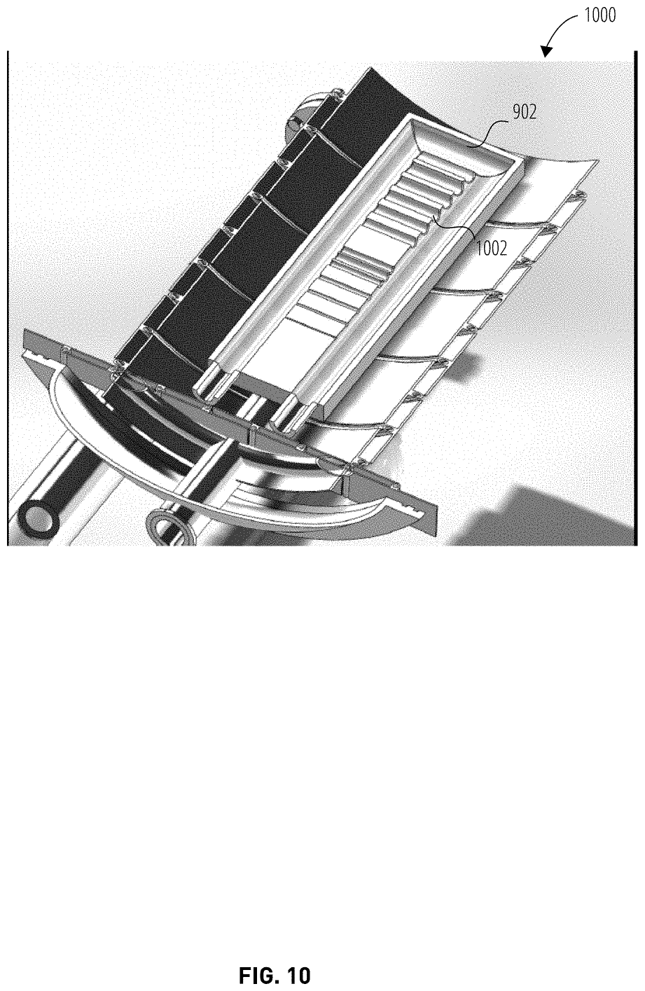

FIG. 10 illustrates a sectional view 1000 of the thermal-vacuum chamber shown in FIG. 9, showing a cut-away portion of the platen 902. The ribbing 1002 allows for passage of nitrogen gas from supply to return.

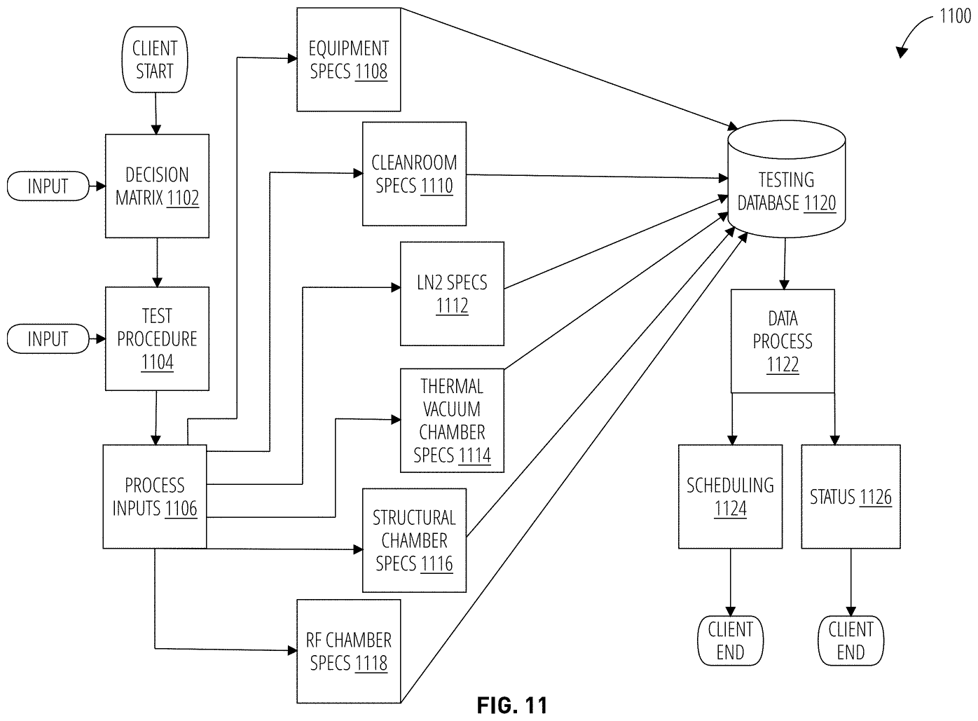

FIG. 11 illustrates a flowchart 1100 in accordance with one embodiment. A client provides a payload (or UUT), and first interacts with decision matrix 1102. In some embodiments, the client can specify the type of orbit, specifications to be met, orbit duration and test start date. For example, the decision matrix 1102 may include a 400 kilometer orbit, military (MIL) standards, Telcordia testing standards and the Society of Automotive Engineers (SAE) standards, a test start date of Jan. 1, 2000 at 00:00, a test conclusion date of Jan. 8, 2000 at 00:00, an orbit duration of 128 minutes and a spacecraft lifetime or 5475 days.

Once decision matrix 1102 is finalized, a test procedure 1104 can be established. In some embodiments, the client can specify the location, the time, a computer-aided design (CAD) model, a calibration date, expected or preformed maintenance dates, pictures, international standards organization (ISO) standards or any other relevant documentation. The process inputs 1106 are then provided, such as but not limited to, the size of the UUT, the thermocouple location, the instrumentation power requirement, the temperature requirements, the altitude requirements, the working hours requirements, the special health considerations, and the security and staffing requirements. For example, the process inputs 1106 may include a UUT with a length of 700 millimeters, a width of 700 millimeters and a height of 200 millimeters, details on the thermocouple location such as the on-board-computer (OBC), the optical aperture, and the structural surface, details on the power requirements for the OBC, the on-board-transceiver and the altitude control, a zenith structure side temperature of −150° C., a high vacuum of 8×10⁻⁵ Torr, 24 hours per day working requirements, a no peanut product in the laboratory or office advisory, a requirement that all personnel have a Canadian citizenship and a minimum staff requirement of 2.

Furthermore, the process inputs 1106 leads to preparation of the operation of basic infrastructure for equipment specs 1108, cleanroom specs 1110 and LN2 specs 1112. The equipment specs 1108 may include the equipment status, such as but not limited to, calibration status, operational status and electrical requirements. For example, the equipment specs 1108 may include calibration status, operation status and electrical requirements on a DAQ, a power supply unit (PSU), the workstation, the mechanical pumps, the turbofans, a transmission control unit (TCU) pressure system, blower fan or heater, valves, a liquid nitrogen tank or delivery system, shrouds, platen and all cooling zones, a chimney, a pressure transducer valve and a chamber pressure transducer. In some embodiments, the cleanroom specs 1110 include the cleanroom heating, ventilation and air conditioning (HVAC) status, particle count and pressure. For example, the cleanroom specs 1110 may include a particle count of 3500 particles per cubic meter of diameter greater than or equal to 0.5 micrometers and a pressure of 101.325 kilopascal per 760 Torr. In some embodiments, LN2 specs 1112 include liquid nitrogen level and pressure. For example, LN2 specs 1112 may include a liquid nitrogen level and pressure of 2000 Liters and 29.4 pounds per square inch respectively.

For the discontinuous thermal vacuum cell 100, thermal vacuum chamber specs 1114 are processed. In some embodiments, these include specs for thermal telemetry, vacuum telemetry, pressure telemetry, residual gas analyzer (RGA) telemetry, quartz crystal microbalance telemetry, and electrical consumption. While a thermal-vacuum cell has been shown in FIG. 1, there are two additional cells: one for structural testing and one for RF testing of the payload. In some embodiments, structural chamber specs 1116 include specs for structural vibration, structural force and structural signal. In some embodiments, RF chamber specs 1118 include specs for RF signal and RF feedback.

Data from each process is stored in a testing database 1120, and processed at a data process 1122, to provide scheduling 1124 and status 1126. It should be noted that the testing data is immediately available to the client via status 1126 module. In some embodiments, the scheduling 1124 includes facility, payroll, staffing, calibration and delivery. In some embodiments, the status 1126 includes UUT status, data models, a graphical user interface (GUI), and an archive.

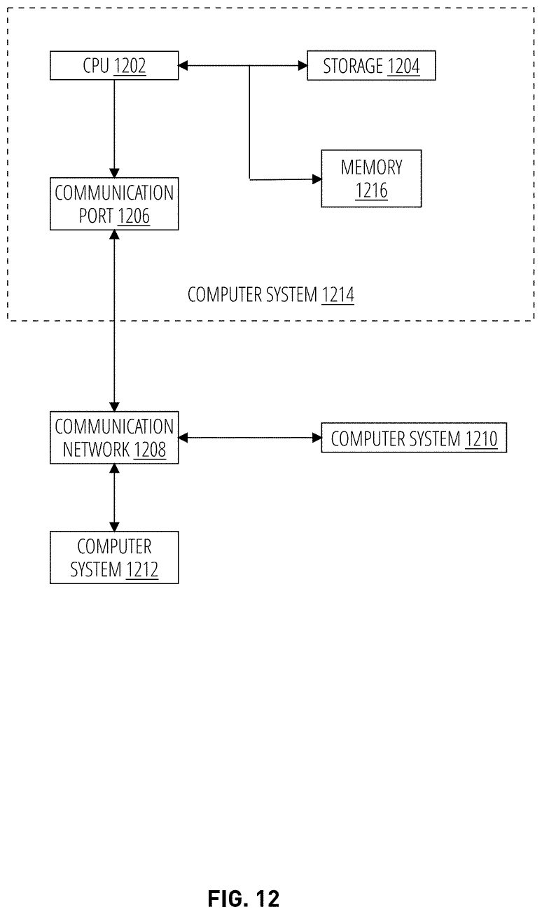

FIG. 12 illustrates a computer system 1214 for testing a space-destined payload in accordance with one embodiment.

The computer system 1214 is a general-purpose computer including a central processing unit 1202, a storage 1204, memory 1216, and communication port 1206. The communication port 1206 can represent a modem, high-speed Ethernet link, or other electronic connection to transmit and receive input/output (I/O) data with respect to other computer systems.

The computer system 1214 is shown connected to a communication network 1208 by way of a communication port 1206. The communication network 1208 can be a local and secure communication network such as an Ethernet network, global secure network, or open architecture such as the Internet. The computer system 1210 and the computer system 1212 can be configured as shown for computer system 1214 or dedicated and secure data terminals. Computer system 1210 and computer system 1212 are also connected to communication network 1208. Computer system 1214, computer system 1212 and computer system 1210 transmit and receive information and data over communication network 1208.

When used as a standalone unit, computer system 1214 can be located in any convenient location. When used as part of a computer network, computer system 1210, computer system 1212 and computer system 1214 can be physically located in any location with access to a modem or communication link to a communication network 1208. Each of the computers runs application software and computer programs, which can be used to display user-interface screens, execute the functionality, and provide the features of the decision matrix and test cells described above. The software is originally provided on computer-readable media, such as compact disks (CDs), magnetic tape, or other mass storage medium. Alternatively, the software is downloaded from electronic links such as the host or vendor website. The software is installed onto the computer system hard drive and/or electronic memory, represented by the storage 1204 and the memory 1216 in FIG. 12 respectively, and is accessed and controlled by the computer's operating system. Software updates are also electronically available on mass storage media or downloadable from the host or vendor website. The software, as provided on the computer-readable media or downloaded from electronic links, represents a computer program product usable with a programmable computer processor having a computer-readable program code embodied within the computer program product. The software contains one or more programming modules, subroutines, computer links, and compilations of executable code, which perform the functions of the supply chain communication platform and standardized modeling tools. The user interacts with the software via keyboard, mouse, voice recognition, and other user-interface devices connected to the computer system. The software stores information and data related to the supply chain communication platform and standardized modeling tools in a database or file structure located on any one of, or combination of, hard drives of the computer systems 1210, 1212, and/or 1214. More generally, the information can be stored on any mass storage 1204 device accessible to computer systems 1210, 1212, and/or 1214. The mass storage device may be part of a distributed computer system.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a standalone program, a component, or other unit suitable for use in a computing environment. A computer program can be deployed to be executed on one computer or can be deployed on multiple computers that are located at one site or distributed across multiple sites and interconnected by a communication network. As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices. The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU). Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive. Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry. To provide for interaction with a user, embodiments of the subject matter described herein can be implemented on a computer having a display device for displaying information to the user and input devices by which the user can provide input to the computer (e.g., a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser. Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”). The computing system can include clients and servers. A client and server are generally remote from each other and typically interact through a communication network. The relationship of client and server arises by virtue of computer programs running on the respective computers and having a client-server relationship to each other. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented system for testing a space-destined payload, the system comprising:
one or more test cells, each test cell designed to test a space-destined payload within a test environment;
a processor; and
a computer memory storing instructions that, when executed by the processor, configure the system to:
receive information related to payload specifics and a space trajectory of the payload;
design the test environment for each test cell based on the information; and
execute one or more tests on the payload within the test environment of each cell.

2. The system of claim 1, wherein the one or more test cells are selected from a thermal-vacuum test cell and a structural test cell and an RF test cell.

3. The system of claim 2, wherein the thermal-vacuum test cell comprises a thermal-vacuum chamber for containing the space-destined payload.

4. The system of claim 1, wherein the instructions, when executed by the processor, further configure the system to provide real-time telemetry data of the payload while being tested in each of the one or more test cells.

5. The system of claim 1, wherein:
the number of cells is greater than one; and
the instructions, when executed by the processor, further configure the system to operate each test cell in sequence.

6. A method for testing a space-destined payload, the method comprising:
receiving information related to one or more payload specifics and a space trajectory of the payload;
designing a test environment for the payload, based on the information;
loading the payload into a first test cell of one or more test cells; and
executing a first set of tests related to the test environment in the first test cell.

7. The method of claim 6, wherein the method further comprises:
after executing the first set of tests, loading the payload into a second test cell of the one or more test cells; and
executing a second set of tests related to the test environment in the second test cell.

8. The method of claim 7, wherein the method further comprises:
after executing the second set of tests, loading the payload into a third test cell of the one or more test cells; and
executing a third series of tests related to the test environment in the third test cell.

9. The method of claim 6, wherein the first test cell is one of a thermal-vacuum test cell, a structural test cell, or an RF test cell.

10. The method of claim 9, wherein the thermal-vacuum test cell comprises a thermal-vacuum chamber.

11. The method of claim 6, wherein the method further comprises providing real-time telemetry data of the payload in the test environment.

12. A non-transitory computer-readable storage medium for testing a space-destined payload, the computer-readable storage medium including instructions that when executed by a computer, cause the computer to:
receive information related to payload specifics and a space trajectory of the payload;
design a test environment for one or more test cells based on the information; and
execute one or more tests on the payload within the test environment of each cell.

13. The non-transitory computer-readable storage medium of claim 12, wherein the one or more test cells are selected from a thermal-vacuum test cell and a structural test cell and an RF test cell.

14. The non-transitory computer-readable storage medium of claim 13, wherein the thermal-vacuum test cell comprises a thermal-vacuum chamber for containing the space-destined payload.

15. The non-transitory computer-readable storage medium of claim 12, wherein the instructions, when executed by the computer, further cause the computer to provide real-time telemetry data of the payload while being tested in each of the one or more test cells.
